(19) United States
(12) Patent Application Publication
(10) Pub. No.: US 2012/0030397 A1
(43) Pub. Date: Feb. 2, 2012

(54) INFORMATION PROCESSING SYSTEM AND METHOD FOR CONTROLLING INFORMATION PROCESSING SYSTEM

(75) Inventors: Akihiro DOUSHITA, Kawasaki (JP); Tooru Yoshinaga, Kawasaki (JP); Hideyuki Kizawa, Kawasaki (JP); Masahide Hiroki, Kawasaki (JP)

(73) Assignee: FUJITSU LIMITED, Kawasaki-shi (JP)

(21) Appl. No.: 13/178,765

(22) Filed: Jul. 8, 2011

(30) Foreign Application Priority Data
Jul. 27, 2010 (JP) 2010-168491

(51) Int. Cl. G06F 13/20; G06F 13/28

(52) U.S. Cl. 710/308; 710/313

(57) ABSTRACT

An information processing system includes a memory, a controller that reads data from a device coupled thereto and writes the data on the memory, a bridge that couples a system bus and an input output bus, the system bus being coupled to the memory and the processor, the input output bus being coupled to the controller, a check code generator that generates a check code from the data read from the device, and a determining unit that determines whether a second check code generated from the data read from the memory corresponds with the first check code.

### CROSS-REFERENCE TO RELATED APPLICATION

This application is based upon and claims the benefit of priority of the prior Japanese Patent Application No. 2010-168491 filed on Jul. 27, 2010, the entire contents of which are incorporated herein by reference.

### FIELD

The embodiment discussed herein is related to an information processing system and a method for controlling the information processing system.

### BACKGROUND

A bus communicating means aiming at establishing a high-reliability system for handling a huge amount of data by using a bus provided with a cyclic redundancy check (CRC) scheme as an error detecting unit for the improvement in reliability of bus communication in a computer system has been known.

A computer with the following configuration is also known. A checksum is generated from write data written to a disk unit from source data and the same data read out of the disk unit. Alternatively, a checksum is generated from read data which is read from the disk unit and used as source data, and the same data read out of the disk unit thereafter. The checksums generated from the same write data or the same read data are compared to assure integrity of the data.

A general-purpose programmable parallel CRC generator capable of generating a CRC code corresponding to every generating polynomial and input data width is also known.

### SUMMARY

According to an aspect of an embodiment, an information processing system includes a memory, a controller that reads data from a device coupled thereto and writes the data on the memory, a bridge that couples a system bus and an input output bus, the system bus being coupled to the memory and the processor, the input output bus being coupled to the controller, a check code generator that generates a check code from the data read from the device, and a determining unit that determines whether a second check code generated from the data read from the memory corresponds with the first check code.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an exemplary configuration of a computer according to a reference example;

FIG. 2 is an explanatory view illustrating an exemplary flow of instructions in the computer illustrated in FIG. 1;

FIG. 3 is a block diagram illustrating an exemplary configuration of a computer according to a first embodiment;

FIG. 4 is a block diagram illustrating an exemplary configuration of a host bus adapter illustrated in FIG. 3;

FIG. 5 is an explanatory view illustrating an exemplary flow of instructions in the computer illustrated in FIG. 3;

FIG. 6 is an explanatory view illustrating an exemplary flow of an operation for reading data from an external storage unit in the computer illustrated in FIG. 3;

FIG. 7 is an explanatory view illustrating an exemplary flow of an operation for writing data to the external storage unit in the computer illustrated in FIG. 3;

FIG. 8 is an explanatory block diagram illustrating an exemplary configuration of a fiber channel driver provided in the computer illustrated in FIG. 3;

FIG. 9 is an explanatory view illustrating an exemplary flow of an operation of the fiber channel driver illustrated in FIG. 8 for reading data from an external storage unit;

FIG. 10 is an explanatory view illustrating an exemplary flow of an operation of the fiber channel driver illustrated in FIG. 8 for writing data to the external storage unit;

FIG. 11 is a block diagram illustrating an exemplary configuration of a check code calculation circuit illustrated in FIG. 4; and

FIG. 12 is an explanatory view illustrating an exemplary configuration of a DMA transfer information data structure according to the first embodiment.

### DESCRIPTION OF EMBODIMENT

Hereinafter, an embodiment may be described.

A first embodiment relates to a computer, as a example of an information processing system, consisting of hardware for reading data from a predetermined device and writing data to a predetermined device via an input/output (IO) bus and software which controls the hardware.

Recently, computers used in, for example, an enterprise system need to be highly reliable to assure integrity of data in the event of any failure in the hardware.

The first embodiment relates to a computer provided with a host bus adapter of an IO bus which does not provide any check code for assuring data integrity, e.g., a peripheral component interconnect (PCI) bus. The check code herein is, for example, information generated for error detection in data, such as a checksum or a CRC code (i.e., inspection information generated in a CRC scheme). According to the first embodiment, such a computer is provided with a circuit for monitoring the reading and writing of data via the IO bus and generating check codes from the data on the IO bus. The computer is also provided with software performing a function to generate a check code from the same data on the memory and compare the generated check code with a check code generated by the check code generating circuit in order to determine whether these check codes are consistent with each other. According to the first embodiment, data integrity in the computer is assured in this manner.

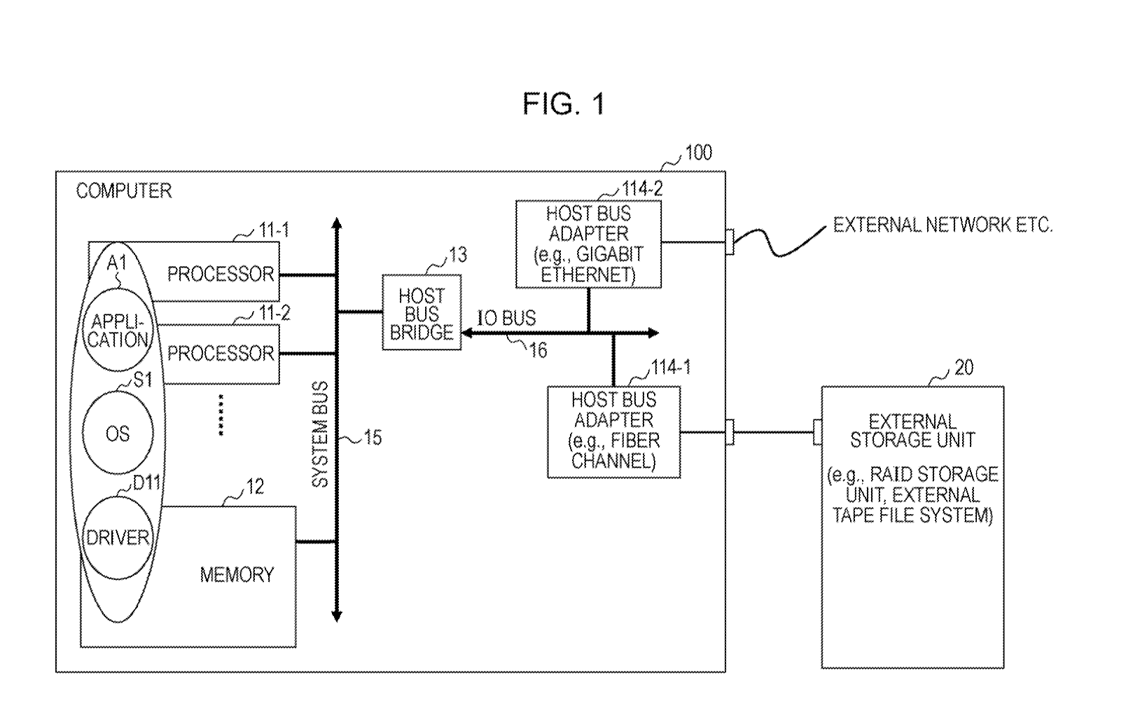

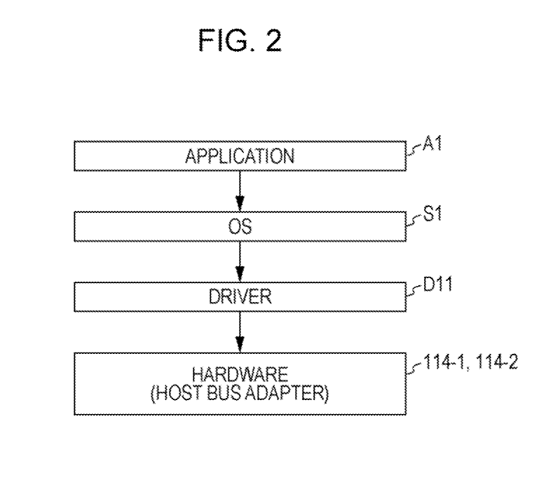

Hereinafter, for ease of description, a computer according to a reference example may be described with reference to FIGS. 1 and 2 prior to providing detailed description of the first embodiment.

A computer 100 illustrated in FIG. 1 includes processors 11-1, 11-2 and so forth, memory 12, a host bus bridge 13 and host bus adapters 114-1 and 114-2. The host bus bridge 13 performs a function to relay a system bus 15 and an IO bus 16 to enable data transfer therebetween. The processors 11-1, 11-2 and so forth, and the memory 12 are connected to the system bus 15. The host bus adapters 114-1 and 114-2 are provided in, for example, slots of the IO bus 16 and perform a function to connect the computer 100 to an external storage unit 20, as a example of a predetermined device, a network and other devices.

An external storage unit (e.g., redundant arrays of inexpensive disks (RAID) and a tape library) 20, a network (“external network etc.” in FIG. 1) and other devices are connected to the computer 100. The computer 100 and the external storage unit 20 are connected with a cable, such as a small computer system interface (SCSI), a fiber channel and a local area network (LAN).

The computer 100 also includes a computer program for operating the host bus adapters 114-1 and 114-2 (i.e., a device driver) D11, an operating system (OS) S1 and an application A1 which operates on the OS S1.

In FIG. 1, the processors (i.e., central processing units) 11-1, 11-2 and so forth execute various software programs, such as the OS S1, the application A1 and the device driver D11. Various software programs, such as the OS S1, the application A1 and the device driver D11, and various types of data used by the software programs are developed on the memory (i.e., a main storage unit) 12 and are read from or written to the processors 11-1, 11-2 and so forth.

In the computer 100 illustrated in FIG. 1, data to be used by the application A1 and the OS S1 is transferred in response to instructions from the software programs (e.g., the application A1, the OS S1 and the device driver D11). More specifically, as illustrated in FIG. 2, when the application A1 issues a request for reading and writing data, the OS S1 receives the request and issues a corresponding request to the device driver D11. The device driver D11 receives the request and issues an access request to the host bus adapters 114-1 and 114-2. In response to the request, the host bus adapters 114-1 and 114-2 read and write data from/to the external storage unit 20 or a network-connected external device (not illustrated).

The data is read from and written to the external storage units 20 by the host bus adapter 114-1 in, for example, a direct memory access (DMA) scheme. That is, a data transfer (i.e., a DMA transfer) is performed between the external storage unit 20 and the memory 12 not via the processors 11-1, 11-2 and so forth under the instructions from the device driver D11.

In the computer 100 illustrated in FIG. 1, the data transferred via the system bus 15 is protected by, for example, an error check and correct (ECC) function. The data transferred via the IO bus (e.g., a PCI bus) 16 is protected in a parity check scheme. If the data is protected in the parity check scheme, a single bit inversion in the data being transferred may be detected; however, multiple bit inversion may not be detected in some cases and therefore the process is continued without detecting errors.

In the first embodiment, the data may be protected in the IO bus 16, in which errors in the data being transferred may not be detected in some cases, to the same degree as in the system bus 15 and therefore reliability of data transferred via the IO bus 16 is improved.

In order to achieve this object, in the first embodiment, check codes for error detection in the data transferred via the IO bus 16 are generated in both hardware and software. The check code generated by the hardware and the check code generated by the software are then compared to assure integrity of the data transferred via the IO bus 16. More specifically, the check codes are generated both by a host bus adapter (i.e., hardware) at which the data is input and output to and from a computer and by a device driver (i.e., software). The device driver then compares the check codes. Here, the host bus adapter generates the check code from the data on the IO bus 16 while the device driver generates the check code from the data on the memory 12. If it is determined by the comparison that the check codes generated by the host bus adapter and by the device driver are consistent with each other, data integrity between the memory 12 and the host bus adapter may be assured.

According to the first embodiment, a later-described check code calculation circuit provided in the host bus adapter calculates a check code for each transfer unit of data transferred between the host bus adapter and the memory 12 among the data transferred via the IO bus 16. The check code may be, for example, a checksum or a CRC code as described above. The device driver (i.e., software) which controls the host bus adapter (i.e., hardware) calculates a check code from the data on the memory 12 for each transfer unit of data. The device driver compares the calculated check code with the check code calculated by the check code calculation circuit to determine whether the check codes are consistent with each other. If the check codes are inconsistent with each other, the device drive reports occurrence of an abnormality in the content of data by performing predetermined error processing. In this manner, data integrity may be assured.

The first embodiment described above has following advantageous effects. Here it is assumed that, when the data is transferred via the IO bus 16 and written to the memory 12, for example, an error occurs in the data, which is normal on the host bus adapter, when the data is transferred via the IO bus 16 or an error occurs in a host bus bridge. It is also assumed that the error relates to multiple bit inversion, which may not be detected through, for example, a parity check in the IO bus 16 and thereby the error is not detected by an ECC function of the system bus 15. With the error, the content of data at the side of the memory 12 and the content of data at the side of the host bus adapter are inconsistent with each other. Therefore, the check code calculated by the check code calculation circuit in the host bus adapter from the data which passes through the host bus adapter, and the check code calculated by the device driver from the data on the memory 12 are inconsistent with each other. As a result of the comparison, it is determined that the check codes are inconsistent with each other and therefore an error is detected. With this, existence of non-integral data may be detected and thus integrity of wide range of data between the JO bus 16 and the memory 12 may be assured.

Here, a data transfer amount between the host bus adapter and the memory 12 may be considered. There is no increase in the number of data transfer except for that required for a process to read the check code calculated and stored by the check code calculation circuit in the host bus adapter when the device driver compares the check codes. Accordingly, influences on the performance of the computer due to the calculation and storing of the check code by the check code calculation circuit, the calculation of the check code by the device driver and the comparison between the check code generated by the device driver and the check code calculated by the check code calculation circuit are subtle.

The check code calculation circuit calculates the check code from the data which passes through the host bus adapter while the device driver calculates the check code from the data on the memory 12. Accordingly, data may be assured on an end-to-end basis between the host bus adapter and the memory 12 and thus reliability is improved as compared with a case in which hardware is separately provided on a bus between the host bus adapter and the memory 12 in order to process the check codes.

Although the check code calculation circuit is provided in the host bus adapter in the foregoing and following description, the location of the check code calculation circuit is not limited to this example. In particular, the check code calculation circuit may be provided outside the host bus adapter as long as it has a configuration for monitoring input/output of data which passes through the host bus adapter and calculating the check codes from the data.

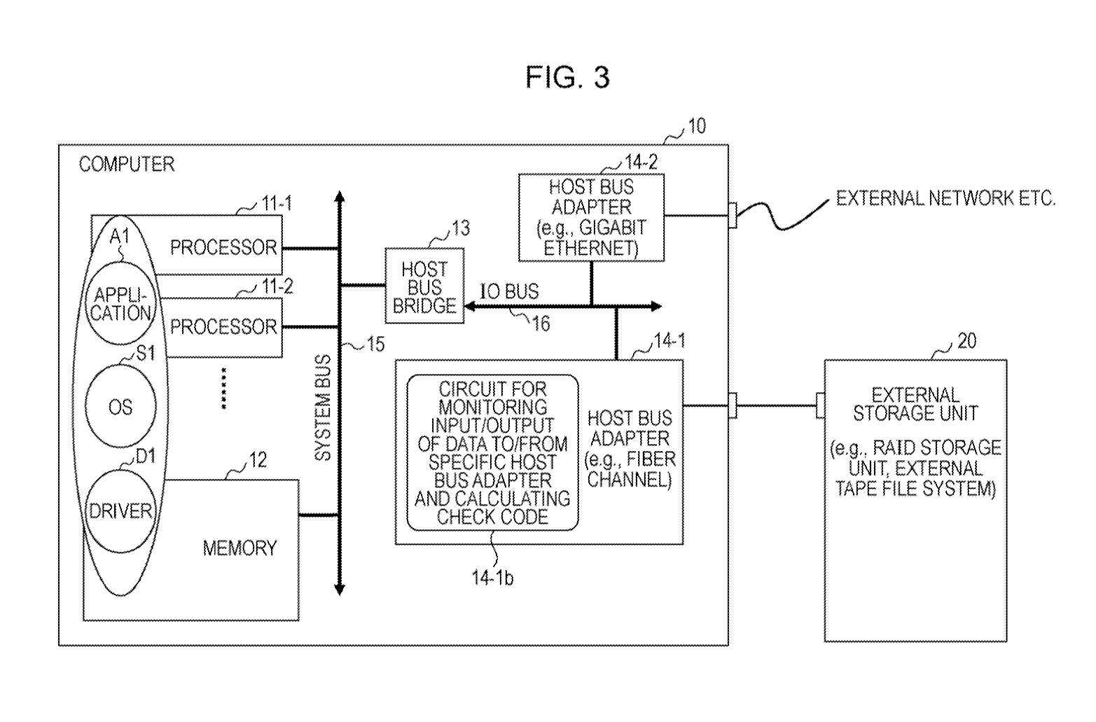

Next, the first embodiment may be described in detail with reference to the drawings. FIG. 3 illustrates a computer 10 according to the first embodiment. The computer 10 has a configuration substantially the same as the configuration of the computer 100 according to the reference example described above with reference to FIG. 1. Similar components are denoted by similar reference numerals and description thereof may be omitted. In the computer 10 according to the first embodiment, host bus adapters 14-1 and 14-2 differ from the host bus adapters 114-1 and 114-2 of the computer 100. A device driver D1 which controls the host bus adapters 14-1 and 14-2 differs from the device driver D11 of the computer 100.

In the following description, the host bus adapter 14-1 which connects the computer 10 to an external storage unit 20, and a device driver D1-1 which controls an operation of the host bus adapter 14-1 among device drivers D1 may be described mainly. However, the host bus adapter 14-2 which connects the computer 10 to, for example, a network and a device driver which controls an operation of the host bus adapter 14-2 among the device drivers D1 respectively have the same functions as those of the host bus adapter 14-1 and the device driver D1-1. In particular, a check code calculation circuit in the host bus adapter calculates and stores a check code of data which passes through the host bus adapter. The device driver calculates a check code of the same data on the memory 12 and compares the calculated check code with a check code calculated by the check code calculation circuit to determine whether these check codes are consistent with each other. If it is determined that the check codes are inconsistent with each other, the device driver performs predetermined error processing and reports that the data is not integral.

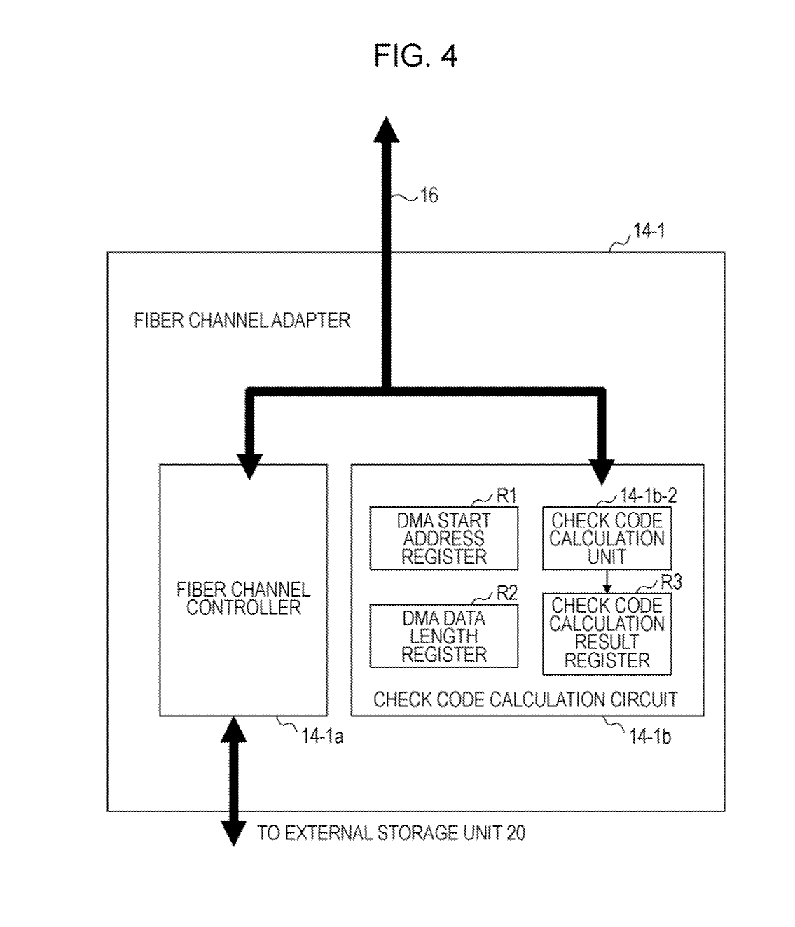

The host bus adapters 14-1 and 14-2 of the computer 10 illustrated in FIG. 3 are hardware which connect the computer 10 with the external storage unit 20, a network and other devices (“external network etc.” in FIG. 3). In particular, the host bus adapter 14-1 according to the first embodiment which connects the computer 10 with the external storage unit 20 is a fiber channel adapter. Thus the host bus adapter 14-1 may sometimes be referred to as a fiber channel adapter 14-1. The fiber channel adapter 14-1 is provided with a fiber channel controller 14-1a (see FIG. 4). The fiber channel controller 14-1a connects an IO bus 16 with the external storage unit 20. The fiber channel controller 14-1a performs a data transfer in a DMA scheme (i.e., a DMA transfer) in response to instructions from the corresponding device driver D1-1.

In the first embodiment, a check code calculation circuit 14-1b which is hardware is provided in the fiber channel adapter 14-1 as illustrated in FIG. 4. The check code calculation circuit 14-1b always monitors the input/output of the data on the IO bus 16 which is connected to the fiber channel controller 14-1a and calculates a check code of the data. The check code calculation circuit 14-1b is constituted by, for example, a field programmable gate array (FPGA). The check code calculation circuit 14-1b calculates a check code for each transfer unit of the data input to the fiber channel controller 14-1a from the IO bus 16 and stores the calculated check code in a register. Similarly, the check code calculation circuit 14-1b calculates a check code for each transfer unit of the data output to the IO bus 16 from the fiber channel controller 14-1a and stores the calculated check code in the register. The register which stores the check codes is accessible from the device driver D1-1.

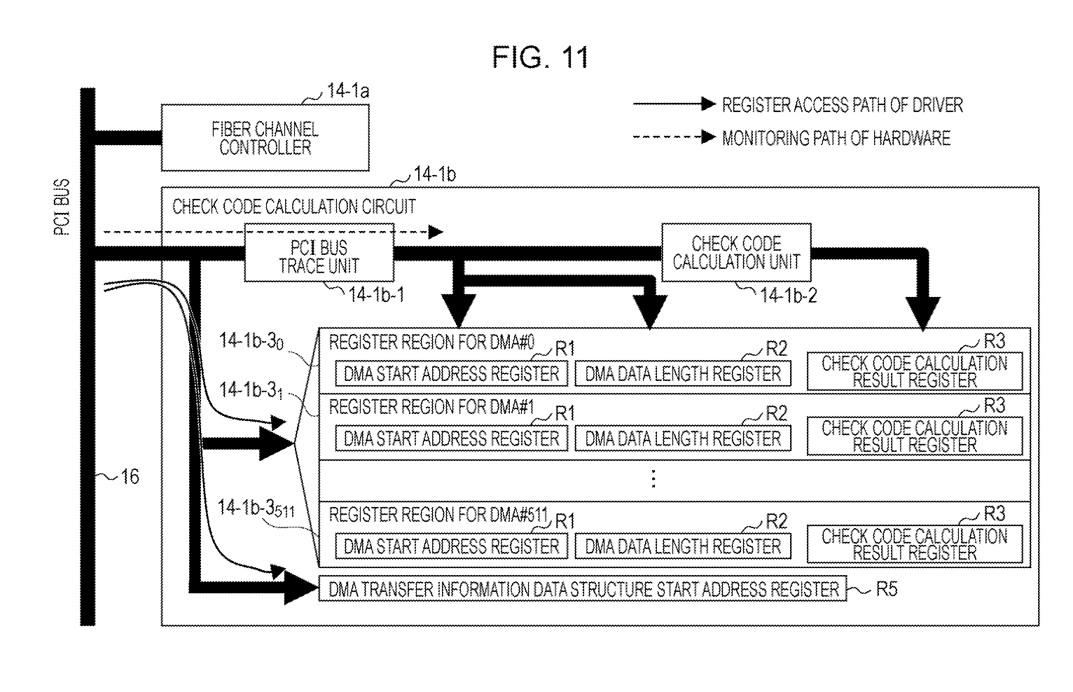

The check code calculation circuit 14-1b includes a check code calculation unit 14-1b-2 which calculates a check code of data transferred via the bus 16 and a check code calculation result register R3 which stores the calculated check code as illustrated in FIG. 4. The check code calculation circuit 14-1b further includes a DMA start address register R1 which stores a transfer start address of the data transferred by the fiber channel controller 14-1a in the DMA scheme. The transfer start address of the data transferred in the DMA scheme represents a start address of memory in which the DMA transfer data is placed. The check code calculation circuit 14-1b further includes a DMA data length register R2 which stores a data length of data transferred by the fiber channel controller 14-1a in the DMA scheme. The data length of the data transferred in the DMA scheme is a data length of data transferred in a single DMA transfer event. A configuration of the check code calculation circuit 14-1b may be described with reference to FIG. 11.

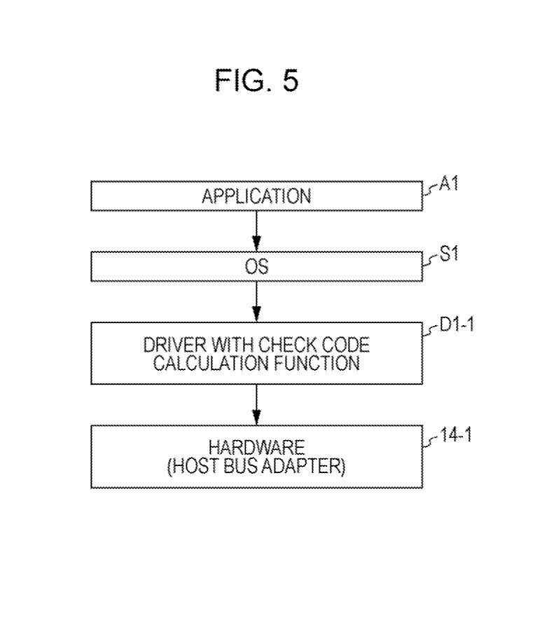

In the computer 10, similarly to the computer 100, when an application A1 issues a request for reading and writing data, an OS S1 receives the request and issues a corresponding request to the device driver D1-1 as illustrated in FIG. 5. For ease of description, only the device driver D1-1 which controls the fiber channel adapter 14-1 is illustrated in FIG. 5. The device driver D1-1 receives the request and issues an access request to the fiber channel adapter 14-1. In response to the request, the fiber channel adapter 14-1 reads and writes data from and to the external storage unit 20.

As described above, the device driver D1-1 is located between the fiber channel adapter 14-1 which is the hardware and the OS S1 as illustrated in FIG. 5; and the device driver D1-1 issues data transfer (i.e., a DMA start) instructions to the fiber channel adapter 14-1 in response to instructions from the OS S1. The device driver D1-1 then controls a data transfer between the memory 12 and the fiber channel adapter 14-1.

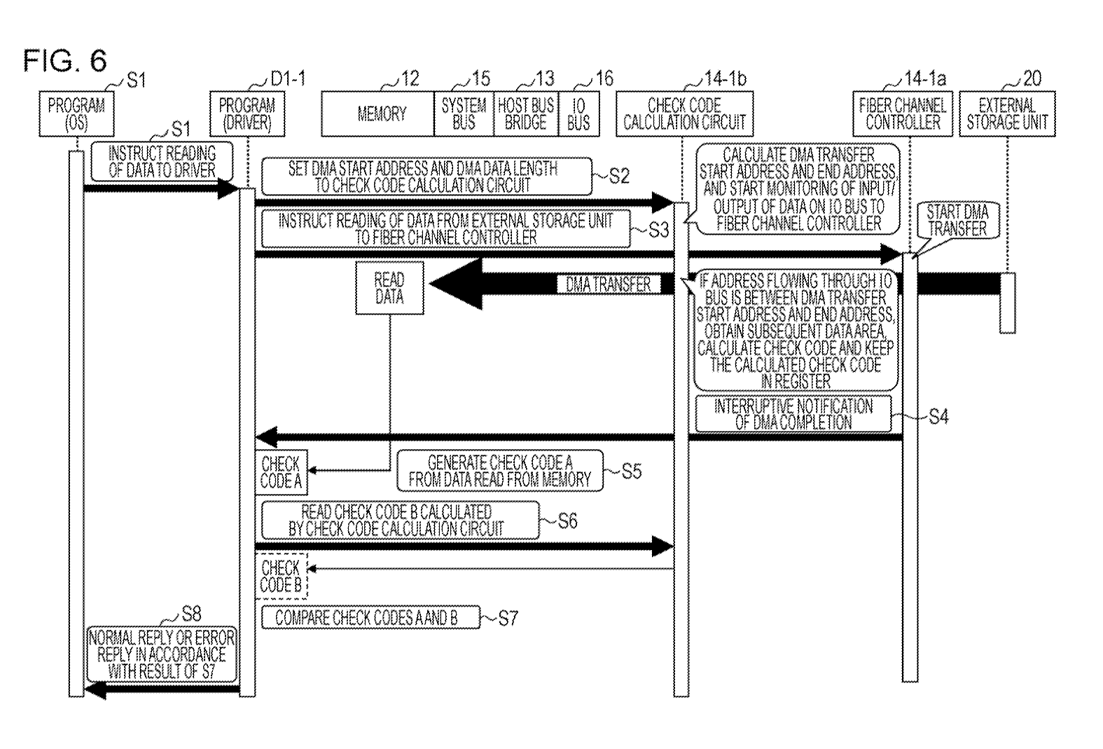

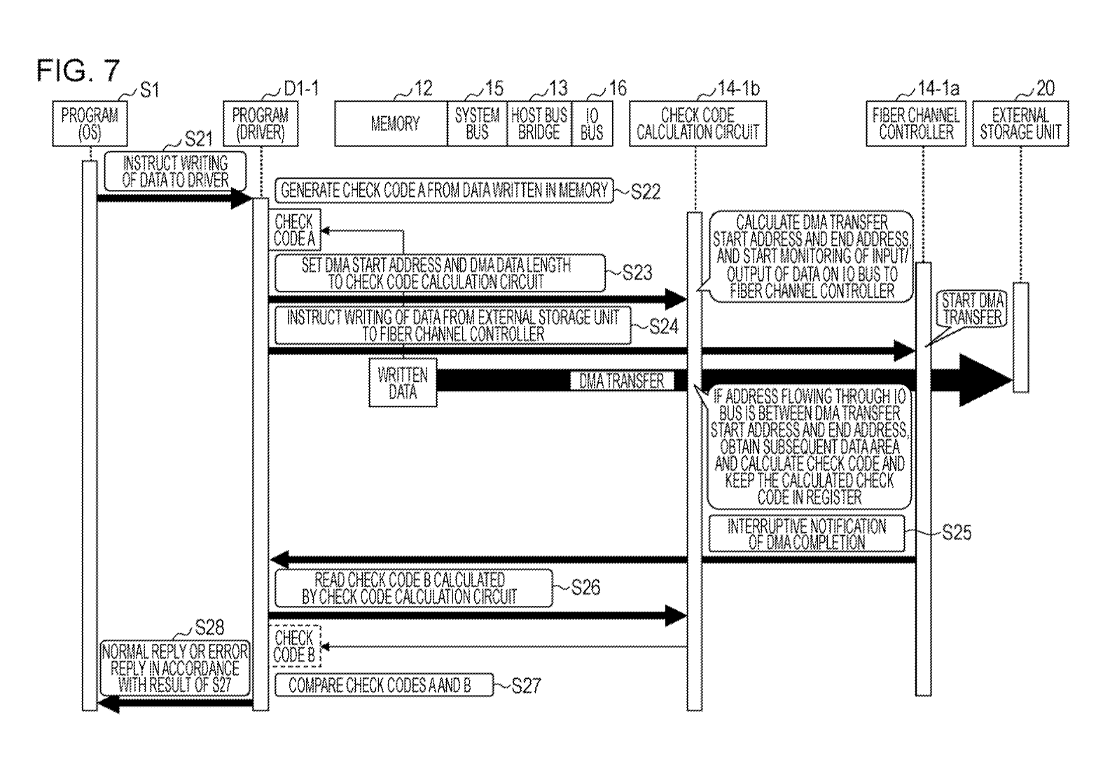

When the device driver D1-1 reads data from the external storage unit 20 (which may be described later with reference to FIG. 6), the device driver D1-1 calculates a check code of the data related to the data transfer on the memory 12 after the data transfer. When the device driver D1-1 writes data to the external storage unit 20 (which may be described later with reference to FIG. 7), the device driver D1-1 calculates a check code of the data related to the data transfer on the memory 12 before the data transfer. The device driver D1-1 controls the check code calculation circuit 14-1b of the fiber channel adapter 14-1, reads the check code calculated by the check code calculation circuit 14-1b and compares the read check code with the check code calculated by the device driver D1-1.

Next, with reference to FIG. 6, an operation of the computer 10 to read data from the external storage unit 20 via the fiber channel adapter 14-1, i.e., to write data to the memory 12 via the fiber channel adapter 14-1, may be described in detail.

In step S1, the application A1 instructs the device driver D1-1 via the OS S1 to read data from the external storage unit 20 via the fiber channel controller 14-1a.

In the next step S2, the device driver D1-1 writes a transfer start address of the data to be DMA transferred to the DMA start address register R1 of the check code calculation circuit 14-1b of the fiber channel adapter 14-1. The device driver D1-1 also writes the data length of the data to be DMA transferred to the DMA data length register R2 of the check code calculation circuit 14-1b. The check code calculation circuit 14-1b adds a DMA data length to a value of a written DMA start address to obtain a transfer end address of the data to be DMA transferred. The transfer end address of the data to be DMA transferred is the address of the last data of the data transferred in a single DMA transfer event. In the next step S3, the check code calculation circuit 14-1b uses the thus-obtained transfer start address and transfer end address of the data to be DMA transferred. That is, the check code calculation circuit 14-1b compares the transfer start address and the transfer end address of the data to be DMA transferred with the address represented by address information which passes through a connection point of the fiber channel controller 14-1a and the IO bus 16.

In the next step S3, the device driver D1-1 instructs the fiber channel controller 14-1a to start the DMA transfer. In response to the instructions, the fiber channel controller 14-1a starts the DMA transfer. After the DMA transfer is started, the check code calculation circuit 14-1b performs the following operations. The check code calculation circuit 14-1b always monitors whether the address represented by the address information flowing through the connection point of the fiber channel controller 14-1a and the IO bus 16 is in a range between “the transfer start address of the data to be DMA transferred” and “the transfer end address of the data to be DMA transferred.” When the address represented by the address information flowing through the connection point is in a range between “the transfer start address of the data to be DMA transferred” and “the transfer end address of the data to be DMA transferred,” the check code calculation circuit 14-1b obtains the data transferred following the address information. The check code calculation circuit 14-1b then calculates the check code of the obtained data and stores the calculated check code (“check code B” in FIG. 6) in the check code calculation result register R3. In the calculation of the check code by the check code calculation circuit 14-1b, a single check code B is obtained for the entire data to be DMA transferred.

In the next step S4, after the DMA transfer is completed, the fiber channel controller 14-1a performs an interruption to the device driver D1-1 and notifies the completion of the DMA transfer.

In the next step S5, the device driver D1-1 reads the data which has been written to the memory 12 by the DMA transfer and calculates the check code (“check code A” in FIG. 6) of the data. Here, similarly to the calculation of the check code by the check code calculation circuit 14-1b, a single check code A is obtained for the entire data to be DMA transferred.

In the next step S6, the device driver D1-1 reads the check code B from the check code calculation result register R3 of the check code calculation circuit 14-1b.

In the next step S7, the device driver D1-1 compares the check code A with the check code B.

In the next step S8, if the comparison result of step S7 is “(the check code A and the check code B are) consistent (with each other),” the device driver D1-1 notifies that the transferred data is integral to the OS S1 and the OS S1 continues subsequent processes (i.e., a normal reply). If, on the other hand, the comparison result of step S7 is “inconsistent,” the device driver D1-1 notifies that the transferred data is not integral to the OS S1 (i.e., an error reply).

Next, with reference to FIG. 7, an operation of the computer 10 to write data to the external storage unit 20 via the fiber channel adapter 14-1, i.e., to read data from the memory 12 via the fiber channel adapter 14-1, may be described in detail.

In step S21, the application A1 instructs, via the OS S1, the device driver D1-1 to read data via the fiber channel controller 14-1a from the memory 12.

In the next step S22, the device driver D1-1 previously reads data read from the memory 12 by the DMA transfer and calculates a check code (“check code A” in FIG. 7) of the data and stores the same in the memory 12. In the calculation of the check code, a single check code A is obtained for the entire data to be DMA transferred.

In the next step S23, the device driver D1-1 writes the transfer start address of the data to be DMA transferred to the DMA start address register R1 of the check code calculation circuit 14-1b of the fiber channel adapter 14-1. The device driver D1-1 also writes the data length of the data to be DMA transferred to the DMA data length register R2 of the check code calculation circuit 14-1b. The check code calculation circuit 14-1b obtains the transfer end address of the data to be DMA transferred by adding the DMA data length to a value of the written DMA start address. In the next step S24, the check code calculation circuit 14-1b uses the thus-obtained transfer start address and transfer end address of the data to be DMA transferred. That is, the check code calculation circuit 14-1b compares the transfer start address of the data to be DMA transferred and the transfer end address with the address represented by the address information which passes through the connection point of the fiber channel controller 14-1a and the IO bus 16.

In the next step S24, the device driver D1-1 instructs the fiber channel controller 14-1a to start the DMA transfer. In response to the instructions, the fiber channel controller 14-1a starts the DMA transfer. After the DMA transfer is started, the check code calculation circuit 14-1b performs the following operations. The check code calculation circuit 14-1b always monitors whether the address represented by the address information flowing through the connection point of the fiber channel controller 14-1a and the IO bus 16 is in a range between “the transfer start address of the data to be DMA transferred” and “the transfer end address of the data to be DMA transferred.” When the address represented by the address information flowing through the connection point is in a range between “the transfer start address of the data to be DMA transferred” and “the transfer end address of the data to be DMA transferred,” the check code calculation circuit 14-1b obtains the data transferred following the address information. The check code calculation circuit 14-1b then calculates the check code of the obtained data and stores the calculated check code (“check code B” in FIG. 7) in the check code calculation result register R3. Here, similarly to the calculation of the check code in step S22, a single check code B is obtained for the entire data to be DMA transferred by the check code calculation circuit 14-1b.

In the next step S25, after the DMA transfer is completed, the fiber channel controller 14-1a performs an interruption to the device driver D1-1 and notifies the completion of the DMA transfer.

In the next step S26, the device driver D1-1 reads the check code B from the check code calculation result register R3 of the check code calculation circuit 14-1b.

In the next step S27, the device driver D1-1 compares the check code A with the check code B.

In the next step S28, if the comparison result of step S27 is “(the check code A and the check code B are) consistent (with each other),” the device driver D1-1 notifies that the transferred data is integral to the OS S1 and the OS S1 continues subsequent processes (i.e., a normal reply). If, on the other hand, the comparison result of step S27 is “inconsistent,” the device driver D1-1 notifies that the transferred data is not integral to the OS S1 (i.e., an error reply).

With the computer 10 according to the first embodiment, the following advantageous effects are obtained. That is, when the data is read from the external storage unit 20 by the DMA transfer and is written to the memory 12, a check code is calculated from the data which passes through the fiber channel adapter 14-1 at a position at which the data is input to the computer 10. Then, before the application A1 uses the data written to the memory 12 by the DMA transfer, the check code calculated from the data on the memory 12 and the check code calculated from the data which passes through the fiber channel adapter 14-1 are compared with each other. If the check codes are inconsistent with each other, an error reply is made. With this, integrity of data which flows through the hardware of the computer 10 may be assured. When data is read from the memory 12 and written to the external storage unit 20 through the DMA transfer, a check code is calculated from the data on the memory 12 read from the memory 12 through the DMA transfer. Then a check code is calculated from the data which passes through the fiber channel adapter 14-1 located at a position at which the data is output from the computer 10. The check code calculated from the data on the memory 12 and the check code calculated from the data which passes through the fiber channel adapter 14-1 are compared with each other. If the comparison result is “inconsistent,” an error reply may be performed to assure integrity of data which flows through the hardware of the computer 10.

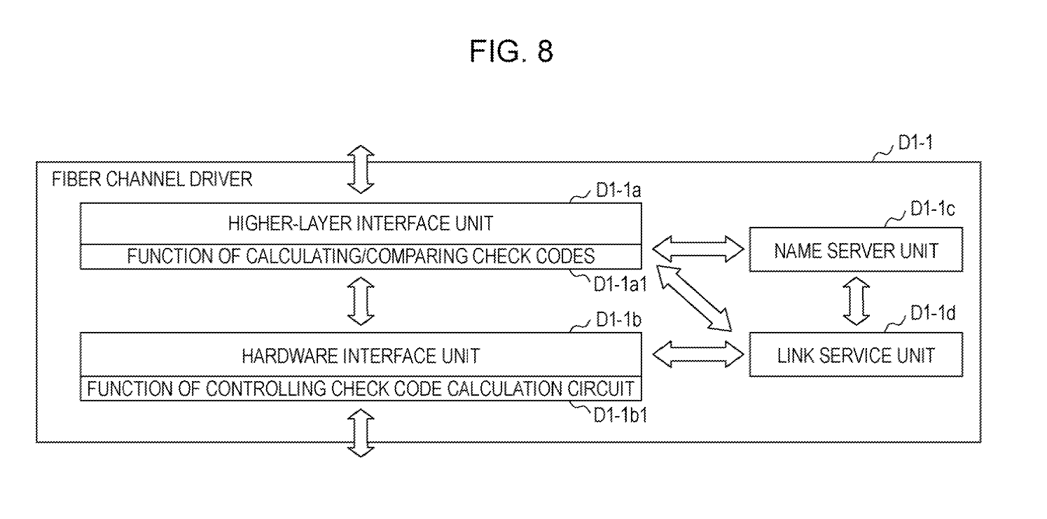

Next, the device driver D1-1 (hereinafter, sometimes referred to as a fiber channel driver D1-1) may be described in detail with reference to FIG. 8. The fiber channel driver D1-1 includes a higher-layer interface unit D1-1a, a hardware interface unit D1-1b, a name server unit D1-1c and a link service unit D1-1d.

The higher-layer interface unit D1-1a uses the name server unit D1-1c and the link service unit D1-1d to obtain a correlation between an SCSI-ID (IDentifier) and an identifier in accordance with a protocol of a fiber channel. Here, an SCSI driver (not illustrated) is provided between the OS S1 and the fiber channel driver D1-1. Thus the higher-layer interface unit D1-1a obtains an identifier in accordance with the protocol of the fiber channel corresponding to the SCSI-ID represented by a higher-order SCSI driver. The higher-layer interface unit D1-1a has a function to convert a request from the SCSI driver into a request in accordance with the protocol of the fiber channel.

The higher-layer interface unit D1-1a then calculates the check code and compares the calculated check code with the check code calculated by the check code calculation circuit 14-1b of the fiber channel adapter 14-1 (“function of calculating/comparing check codes D1-1a1” in FIG. 8). These operations correspond to steps S5 to S7 of FIG. 6 and step S22, S26 and S27 of FIG. 7.

The hardware interface unit D1-1b controls the fiber channel controller 14-1a. The hardware interface unit D1-1b also controls the check code calculation circuit 14-1b (“function of controlling check code calculation” D1-1b1 in FIG. 8).

The link service unit D1-1d performs, for example, a negotiation necessary for the computer 10 to start a connection with the external storage unit 20. If a fiber channel switch (not illustrated) is used for the communication with the external storage unit 20, the link service unit D1-1d performs, for example, a negotiation necessary for the start of a connection with the fiber channel switch.

The external storage unit 20 is registered in the name server unit D1-1c and the higher-layer interface unit D1-1a may obtain a correlation between the SCSI-ID (IDentifier) and the identifier in accordance with the protocol of the fiber channel by referring to the registration. If the computer 10 uses the fiber channel switch for the communication with the external storage unit 20 of the computer 10, the fiber channel switch is registered in the name server unit D1-1c. Information about the external storage unit 20 stored in the fiber channel switch is also registered in the name server unit D1-1c. In this case, the higher-layer interface unit D1-1a obtains a correlation between the SCSI-ID (IDentifier) and the identifier in accordance with the protocol of the fiber channel regarding the fiber channel switch by referring to the registration.

Next, an operation of the fiber channel driver D1-1 which has been described with reference to FIG. 8 may be described in detail. Here, the IO bus 16 is a PCI bus.

The fiber channel driver D1-1 first performs initial setting of the fiber channel controller 14-1a and the check code calculation circuit 14-1b which are connected to the PCI bus 16. More specifically, the fiber channel driver D1-1 performs a configuration access to the fiber channel controller 14-1a and the check code calculation circuit 14-1b. The configuration access is an access performed by using a configuration space of the PCI bus 16. The fiber channel driver D1-1 performs setting of registers (not illustrated) of the fiber channel controller 14-1a and the check code calculation circuit 14-1b by the configuration access. With the setting of the registers, the fiber channel driver D1-1 allocates a memory space of the PCI bus 16 used by each function of the fiber channel controller 14-1a and the check code calculation circuit 14-1b.

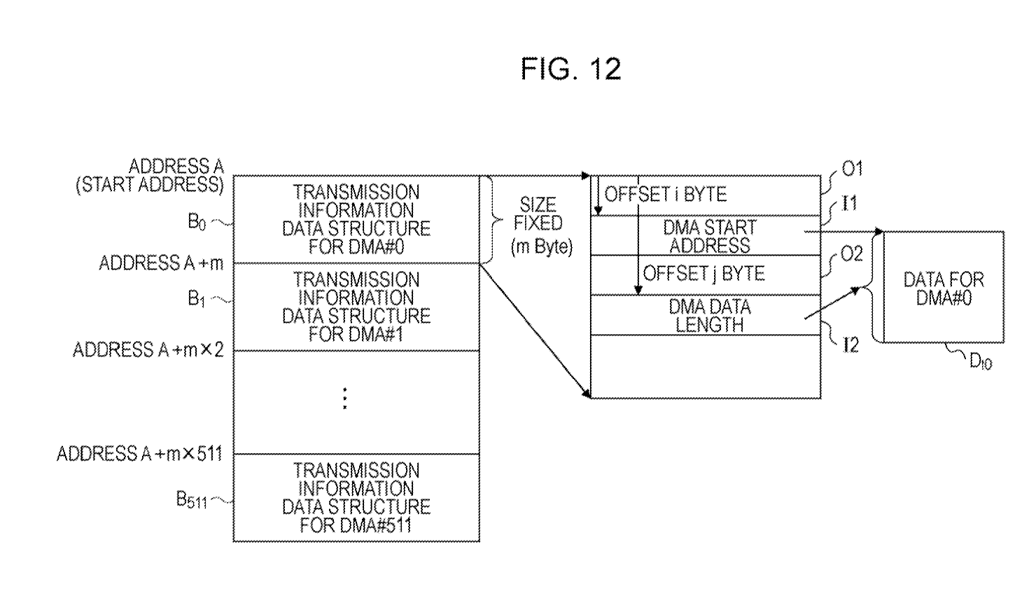

The fiber channel driver D1-1 also performs setting of, for example, a DMA transfer information data structure used by the DMA transfer on the memory 12. The DMA transfer information data structure may be described later with reference to FIG. 12.

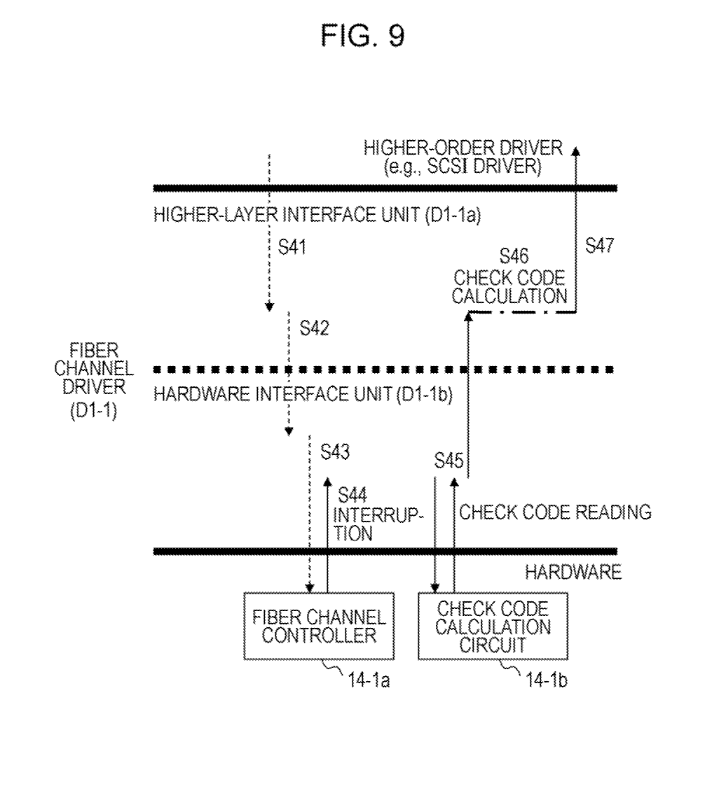

Next, an operation of the fiber channel driver D1-1 when the computer 10 reads data from the external storage unit 20 by the DMA transfer may be described with reference to FIG. 9.

When a data reading request is issued by a higher layer (which is the SCSI driver as described above) in step S41, the higher-layer interface unit D1-1a determines validity of the reading request in step S42. If the reading request is valid, the higher-layer interface unit D1-1a issues instructions to the hardware interface unit D1-1b to read the data.

In the next step S43, the hardware interface unit D1-1b issues instructions regarding the DMA transfer to the fiber channel controller 14-1a in response to the instructions for reading the data.

When an interruption is made by the fiber channel controller 14-1a to notify the completion of the DMA transfer in the next step S44, the hardware interface unit D1-1b accesses the check code calculation circuit 14-1b in step S45. Then the hardware interface unit D1-1b reads the check code calculated and stored by the check code calculation circuit 14-1b and provides the read check code to the higher-layer interface unit D1-1a together with a notice of the completion of reading of data.

In the next step S46, the higher-layer interface unit D1-1a calculates a check code of the data on the memory 12 related to the reading of data. The higher-layer interface unit D1-1a then compares the calculated check code and the check code provided by the hardware interface unit D1-1b (step S47). If the comparison result is “inconsistent,” an error reply is made to the higher layer (i.e., the SCSI driver). If the comparison result is “consistent,” a normal reply is made to the higher layer (i.e., the SCSI driver).

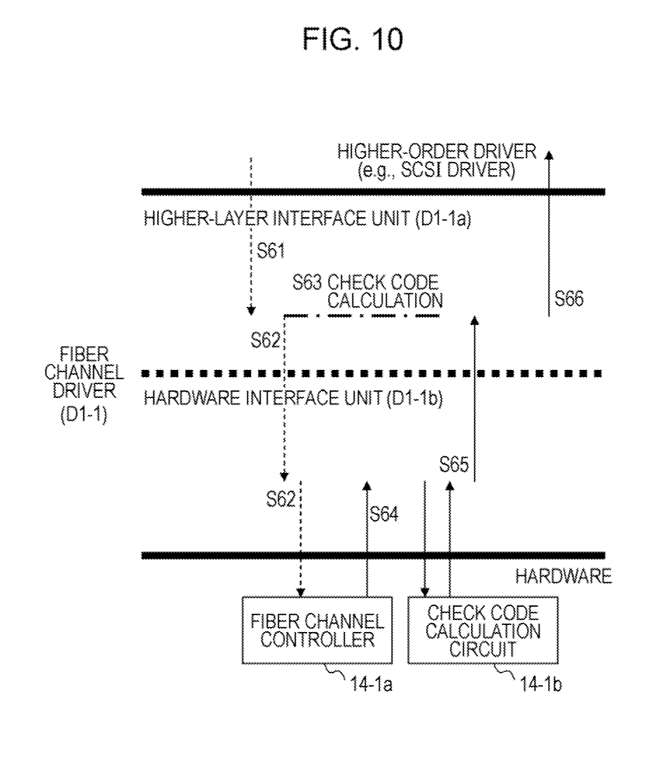

Next, an operation of the fiber channel driver D1-1 when the computer 10 writes data to the external storage unit 20 by the DMA transfer may be described with reference to FIG. 10.

When a write request of data is provided from the higher layer (i.e., the SCSI driver) in step S61, the higher-layer interface unit D1-1a determines validity of the write request in step S62. If the write request is valid, the higher-layer interface unit D1-1a issues instructions of writing data to the hardware interface unit D1-1b. The hardware interface unit D1-1b issues instructions of the DMA transfer to the fiber channel controller 14-1a in response to the instructions of writing the data. The higher-layer interface unit D1-1a calculates the check code of the data related to the writing of data to the memory 12 in step S63.

Next, when an interruption to notify the completion of the DMA transfer is made by the fiber channel controller 14-1a in step S64, the hardware interface unit D1-1b accesses the check code calculation circuit 14-1b in step S65. The hardware interface unit D1-1b then reads the check code calculated and stored by the check code calculation circuit 14-1b and provides the read check code to the higher-layer interface unit D1-1a together with a notice of the completion of writing of data.

In the next step S66, the higher-layer interface unit D1-1a compares the check code calculated in step S63 with the check code provided by the hardware interface unit D1-1b. If the comparison result is inconsistent,” an error reply is made to the higher layer (i.e., the SCSI driver). If the comparison result is “consistent,” a normal reply is made to the higher layer (i.e., the SCSI driver).

Next, an exemplary hardware configuration of the check code calculation circuit 14-1b may be described with reference to FIG. 11 and an exemplary configuration of the DMA transfer information data structure may be described with reference to FIG. 12. In these exemplary configurations, the IO bus 16 is a PCI bus and the maximum number of the simultaneously issued DMA transfer instructions is 512.

The check code calculation circuit 14-1b illustrated in FIG. 11 is provided with a PCI bus trace unit 14-1b-1, a check code calculation unit 14-1b-2, 512 register regions 14-1b-30, 14-1b-31, . . . , 14-1b-3511 and a DMA transfer information data structure start address register R5.

The PCI bus trace unit 14-1b-1 monitors address information flowing through the PCI bus 16 and takes information about the DMA start address and the DMA data length included in the DMA transfer information data structure into the register region from the PCI bus 16. That is, the DMA start address is stored in the DMA start address register R1 and the DMA data length is stored in the DMA data length register R2.

The PCI bus trace unit 14-1b-1 obtains the transfer end address of the data to be DMA transferred (i.e., a DMA end address) from the information of the DMA start address and the DMA data length which have been taken into the register region and obtains data between the DMA start address and the DMA end address from the PCI bus 16. The PCI bus trace unit 14-1b-1 then instructs the check code calculation unit 14-1b-2 to calculate a check code of the obtained data.

In response to the instructions from the PCI bus trace unit 14-1b-1, the check code calculation unit 14-1b-2 calculates the check code of the data and stores the calculated check code in the check code calculation result register R3 of the register region.

The 512 register regions 14-1b-30, 14-1b-31, . . . , 14-1b-3511 are provided to correspond to the maximum number of the DMA transfer instructions issued simultaneously (e.g., 512 in the example illustrated in FIGS. 11 and 12). Each register region includes a DMA start address register R1, a DMA data length register R2 and a check code calculation result register R3. As described above, the information about the DMA start address and the DMA data length taken by the PCI bus trace unit 14-1b-1 is stored in the DMA start address register R1 and the DMA data length register R2 of the register region, respectively. A calculation result of the check code calculated by the check code calculation unit 14-1b-2 is stored in the check code calculation result register R3.

A start address of the DMA transfer information data structure which the fiber channel driver D1-1 sets to the memory 12 is stored in the DMA transfer information data structure start address register R5. The fiber channel driver D1-1 sets the DMA transfer information data structure start address register R5 at the time of initial setting.

The 512 DMA transfer information data structures B0, B1, . . . , B511 illustrated in FIG. 12 are used as information for the control of the DMA data transfer between the fiber channel driver D1-1 and the fiber channel controller 14-1a. A size of a single DMA transfer instruction (e.g., B0) among the 512 DMA transfer information data structures B0, B1, . . . , B511 is fixed (m bytes) and the amount of the maximum simultaneously issued DMA transfer instructions are arranged serially (in-series). The DMA transfer information data structure corresponding to a single DMA transfer instruction (e.g., B0) includes various information about DMA transfers. Among these, as information mainly used by the check code calculation circuit 14-1b, information about the start address (i.e., a DMA start address I1) of the data to be DMA transferred (e.g., the 0th data to be DMA transferred Dt0) and information about the data length (i.e., a DMA data length I2) of the data are included. As illustrated, the DMA start address 11 is stored at an offset position O1 (i bytes) from a leading address of the DMA transfer information data structure B0 and the DMA data length I2 is stored at an offset position O2 (j bytes). The fiber channel driver D1-1 arranges the DMA transfer information data structures B0, B1, . . . , B511 illustrated in FIG. 12 in the memory 12.

Next, operation procedures (1) to (8) of the computer 10 at the time of starting the DMA transfer when the check code calculation circuit 14-1b illustrated in FIG. 11 and the DMA transfer information data structure illustrated in FIG. 12 are applied may be described.

The DMA transfer is started by the computer 10 causing the fiber channel controller 14-1a to read information about the DMA transfer information data structure and causing the fiber channel controller 14-1a to recognize the information about the DMA transfer.

(1) First, at the time of initial setting, the fiber channel driver D1-1 sets a start address of the DMA transfer information data structure (“address A” in FIG. 12) to the DMA transfer information data structure start address register R5 of the check code calculation circuit 14-1b.

(2) Next, the fiber channel driver D1-1 selects the DMA transfer information data structure to be used in response to the reception of the data transfer request from a higher layer. More specifically, the fiber channel driver D1-1 extracts the DMA transfer information data structures which are not currently used from among the 512 DMA transfer information data structures and selects a DMA transfer information data structure to be used from among the extracted DMA transfer information data structures. For example, it is assumed that the fiber channel driver D1-1 has selected the DMA transfer information data structure B0 (“transmission information data structure for DMA#0” in FIG. 12) as the DMA transfer information data structure to be used.

(3) In this case, the fiber channel driver D1-1 then rewrites the information about the DMA start address I1 and the DMA data length I2 of the DMA transfer information data structure B0 on the memory 12 in accordance with the corresponding information included in the data transfer request received from the higher layer.

(4) The fiber channel driver D1-1 then performs the following operations. Here, a register region corresponding to the DMA transfer information data structure B0 selected as the DMA transfer information data structure is a register region 14-1b-30 (“register region for DMA#0” in FIG. 11) among the register regions of the check code calculation circuit. Thus, the fiber channel driver D1-1 initializes (e.g., clears to “0”) the check code calculation result register R3 included in the register region 14-1b-30.

(5) Next, the fiber channel driver D1-1 instructs the fiber channel controller 14-1a to read or write the data. In response to the instructions of reading or writing the data, the fiber channel controller 14-1a reads the DMA transfer information data structure B0 on the selected memory 12 as the DMA transfer information data structure to be used. In this manner, information about the DMA transfer information data structure B0 is read from the memory 12 and is caused to flow through the IO bus 16.

(6) Next, the check code calculation circuit 14-1b monitors the address information which flows through the connection point of the fiber channel controller 14-1a and the IO bus 16. The check code calculation circuit 14-1b then determines whether the address representing the address information is in a range of the address on the memory 12 to which the DMA transfer information data structures B0 to B511 have been set (i.e., “address A” to “address A+m×n” (n is 512 in the example of FIG. 12)). When it is determined that the address is in the above range and, for example, in the range of the DMA transfer information data structure B0, the check code calculation circuit 14-1b performs the following operations. The check code calculation circuit 14-1b takes the information about the DMA start address I1 (i.e., the offset O1) and the DMA data length I2 (i.e., the offset O2) of the DMA transfer information data structure B0 transferred following the address information into the DMA start address register and the DMA data length register of the corresponding number (here No. 0). That is, the DMA start address I1 and the DMA data length I2 are stored in the DMA start address register R1 and the DMA data length register R2 of the register region 14-1b-30, respectively.

(7) Next, the fiber channel controller 14-1a starts the DMA transfer between itself and the memory 12 under the instructions of the DMA transfer.

(8) Next, the check code calculation circuit 14-1b monitors the address information which flows through the connection point of the fiber channel controller 14-1a and the IO bus 16. The check code calculation circuit 14-1b then determines whether the address represented by the address information is in a range between the transfer start address (i.e., the DMA start address) and the transfer end address (i.e., the DMA end address) of the data to be DMA transferred. The DMA start address and the DMA end address are obtained from the information stored in the DMA start address register R1 and the DMA data length register R2 of the register region 14-1b-30 in the operation procedure (6), respectively. That is, the DMA start address is the DMA start address stored in the DMA start address register R1. The DMA end address is obtained by adding each data length of the data stored in the DMA data length register R2 to the DMA start address. If it is determined as a result of determination described above that the address represented by the address information is in the range between the DMA start address and the DMA end address, the check code calculation circuit 14-1b takes the data transferred following the address information. The check code calculation circuit 14-1b calculates the check code of the thus-taken data and stores the calculated check code in the check code calculation result register R3 of the register region 14-1b-30. The check code calculated and stored by the check code calculation circuit 14-1b herein is a single check code obtained for all the data to be subject to the single DMA transfer instruction. Accordingly, if the check code is a checksum or a CRC code, for example, the check code may be updated sequentially in accordance with the data sequentially transferred in a series of data transfer processes related to a single DMA transfer instruction. It is possible that the single check code is obtained for all the data subject to the single DMA transfer instruction as a result of the above-described update when the data transfer related to the single DMA transfer instruction is completed.

At the time of starting of the DMA transfer related to a second DMA transfer instruction, the operation procedures (2) to (8) described above are performed in this order. A DMA transfer information data structure Bk is selected herein as the “DMA transfer information data structure to be used” selected in the operation procedure (2) (1≦k≦511). In this case, a range of the address of the DMA transfer information data structure Bk on the memory 12 is between an “address A+km” to an “address A+(k+1) m−1.” A register region of a circuit of the corresponding check code calculation circuit 14-1b is a register 14-1b-3k. The operation procedures (1) to (8) described above are performed at the time of starting for the reading of data from the external storage unit 20 and are also performed at the time of starting for the writing of data to the external storage unit 20 in the DMA transfer.

Next, a check code calculation method executed by the check code calculation circuit 14-1b may be described.

A preferable check code calculation method is, for example, a method of calculating a checksum as a check code and a method of calculating a CRC code as a check code. The check code calculation method is preferably selected in consideration of a circuit size of the check code calculation circuit 14-1b, a calculation performance of the check code calculation circuit 14-1b and other factors.

It is required that the check code calculation method executed by the check code calculation circuit (hardware) 14-1b and the check code calculation method executed by the fiber channel driver (software) D1-1 are consistent with each other. That is, when a checksum calculation method is selected, carries produced during the calculation may be handled in a consistent manner. When a CRC code calculation method is selected, generating polynomials used for the calculation of the CRC code may be consistent. In either calculation method, it is required that, for example, bit arrangements (i.e., endianness) of each byte of the data may be consistent.

All examples and conditional language recited herein are intended for pedagogical purposes to aid the reader in understanding the embodiment and the concepts contributed by the inventor to furthering the art, and are to be construed as being without limitation to such specifically recited examples and conditions, nor does the organization of such examples in the specification relate to a illustrating of the superiority and inferiority of the embodiment. Although the embodiment of the present invention has been described in detail, it should be understood that the various changes, substitutions, and alterations could be made hereto without departing from the spirit and scope of the invention.

What is claimed is:

1. An information processing system comprising:
a memory;
a controller that reads data from a device coupled thereto and writes the data on the memory;
a bridge that couples a system bus and an input output bus, the system bus being coupled to the memory and the processor, the input output bus being coupled to the controller;
a check code generator that generates a check code from the data read from the device; and
a determining unit that determines whether a second check code generated from the data read from the memory corresponds with the first check code.

2. The information processing system according to claim 1, wherein the determining unit is a processor.

3. The information processing system according to claim 1, wherein the controller reads the first data from the memory by using a Direct Memory Access (DMA) transfer method.

4. A method for controlling an information processing system including a memory, a controller, a check code generator and a determining unit, the method comprising:
reading, by the controller, first data from a device connected to the controller;
generating, by the check code generator, a first check code from the first data read from the predetermined device;
writing, by the controller, the first data on the memory;
generating, by the determining unit, a second check code from the first data read from the memory; and
determining, by the determining unit, whether the second check code corresponds with the first check code.

5. The method according to claim 4, further comprising:
reading, by the controller, second data from the memory;
writing, by the controller, the second data on the predetermined device;
generating, by the check code generator, a third check code from the second data written on the predetermined device;
generating, by the determining unit, a fourth check code from the second data read from the memory; and
determining, by the determining unit, whether the fourth check code corresponds with the third check code.

6. The method according to claim 4, further comprising:
writing, by the controller, the first data on the memory by using a Direct Memory Access (DMA) transfer method; and
reading, by the controller, the second data from the memory by using the DMA transfer method.

7. A computer-readable, non-transitory medium storing a program that causes a processor to execute a control of an information processing system including a memory for storing the program and data, the processor for reading and executing the program stored in the memory, a controller, a bridge, a check code generator and a determining unit, the bridge being for coupling a system bus and an input output bus, the system bus being coupled to the memory and the processor, the input output bus being coupled to the controller and the check code generator, the control comprising:
obtaining a check code generated from first data read by the controller from the predetermined device;
generating a second check code from the first data read from the memory; and
determining whether the second check code corresponds with the first check code.

8. The computer-readable, non-transitory medium according to claim 7, wherein the control further comprises:
writing second data on the memory;
obtaining a third check code generated by the check code generator from the second data read from the memory by the controller;
generating a fourth check code from the second data read from the memory; and
determining whether the fourth check code corresponds with the third check code.
